(19) United States
(12) Patent Application Publication
(10) Pub. No.: US 2004/0266480 A1
(43) Pub. Date: Dec. 30, 2004

(54) System and method for implementing sensor functionality in mobile devices

(76) Inventors: Kari Tapani Hjelt, Espoo (FI); Santtu Naukkarinen, Espoo (FI); Tapani Ryhanen, Helsinki (FI); Jarkko Sairanen, Espoo (FI); Jukka H. Salminen, Espoo (FI); Samuli Silanto, Helsinki (FI); Ulrica Bohne, Johanneshov (SE); Michel Gillet, Helsinki (FI); Juha Rakkola, Espoo (FI)

Correspondence Address: Crawford Maunu PLLC, Suite 390, 1270 Northland Drive, St. Paul, MN, 55120, US

(21) Appl. No.: 10/607,832

(22) Filed: Jun. 27, 2003

(51) Int. Cl. H04M 1/00; H04B 1/38

(52) U.S. Cl. 455/558; 455/41.2; 455/90.1

(57) ABSTRACT

A system, apparatus and method for incorporating sensor functionality into mobile communication devices having a host process and employing at least one memory, such as a removable memory card. Access to the removable memory card by the host process is facilitated using a digital interface, and storing sensor data from one or more sensor modules into a local memory. The host process of the mobile communication device is coupled to the local memory via the digital interface which is used by the host process to access the removable memory card. The sensor data may then be accessed from the local memory by the host process via the digital interface.

### FIELD OF THE INVENTION

This invention relates in general to mobile sensing devices and architectures, and more particularly to a method and apparatus for removably connecting sensor functionality into mobile devices using a scalable digital interface.

### BACKGROUND OF THE INVENTION

When originally introduced into the marketplace, analog mobile telephones used exclusively for voice communications were viewed by many as a luxury. Today, mobile communication devices are highly important, multi-faceted communication tools. A substantial segment of society now carries their mobile devices with them wherever they go. These mobile devices include, for example, mobile phones, Personal Digital Assistants (PDAs), laptop/notebook computers, and the like. The popularity of these devices and the ability to communicate “wirelessly” has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow voice communication, but also facilitate messaging, multimedia communications, e-mail, Internet browsing, and access to a wide range of wireless applications and services.

With the continual improvement to networking infrastructures and mobile device technologies, more features have been added to mobile devices. For example, location-based services are being incorporated into mobile devices, such as services based on Global Positioning System (GPS) technology. In essence, GPS services serve as position or location sensors for mobile users. Other sensing devices may be incorporated into mobile devices, to enhance user experiences and provide conveniences otherwise unavailable to people on the move.

Wireless connectivity coupled with sensing and actuation functionality provides for a vast array of ubiquitous or pervasive computing applications, where intelligent consumer devices can communicate with one another. Among the broad categories of such ubiquitous communication are personal devices and intelligent environments. Future personal devices will increasingly morph functionality, otherwise required of multiple devices, into single, powerful tools.

With respect to incorporating sensor functionality into such devices, a problem of implementing such functionality exists. Currently, implementing the sensor applications is problematic because the applications and the business opportunities are fragmented. Further, no practical guidelines exist for creating new products for such fragmented markets.

Accordingly, there is a need in the communication industry for effectively managing the implementation of sensor functionality into mobile devices. The present invention fulfills these and other needs, and offers other advantages over the prior art.

### SUMMARY OF THE INVENTION

To overcome limitations in the prior art described above, and to overcome other limitations that will become apparent upon reading and understanding the present specification, the present invention discloses a system, apparatus and method for removably connecting sensor functionality into mobile devices using a digital interface.

In accordance with one embodiment of the invention, a sensor card is provided that includes one or more sensors to respectively collect sensor data. A memory is provided, as well as sensor interface circuitry coupled to the sensors to receive the sensor data and to store the sensor data in the memory. A digital interface is configured for connection to a corresponding digital interface on a mobile communication device, to facilitate access to the memory by a host process operating on the mobile communication device when the sensor card is connected to the mobile communication device via the digital interface.

In more particular embodiments of such a sensor card, the sensor interface circuitry includes a bridge circuit coupled between the sensors and an external memory that also implements the digital interface. The bridge facilitates mapping of the sensor data into a defined portion of the external memory, where the host process receives the sensor data via the defined portion of the external memory. In a more particular embodiment, the bridge includes a switching function for switching between the defined portion of the external memory and remaining portions of the external memory, in order to allow the host process to access the sensor data and other non-sensor data respectively.

In other particular embodiments of such a sensor card, a housing is provided to house the sensor card when the sensor card is not connected to the mobile communication device, where the housing may include a power source to provide power to the sensor card in order to allow the sensor data to be stored in the memory when the sensor card is housed within the housing. In another embodiment, a substrate is included on which the sensor elements, the memory, and the sensor interface circuitry are provided. A housing may then be provided to encapsulate the substrate, such as a plastic encapsulation. In other particular embodiments, the sensor interface circuitry includes a memory controller coupled to the digital interface, where the memory controller is configured to enable access to the memory by both the sensor interface circuitry and the host process. More particularly, the memory controller may include a direct memory access (DMA) controller to facilitate DMA transfers from the sensor interface circuitry to the memory.

In still more particular embodiments of such a sensor card, the digital interface may also, or instead, involve a short range wireless interface for wirelessly coupling the memory and sensor data to the host process operating on the mobile communication device. For example, the short range wireless interface may include a Bluetooth interface, an infrared (IR) interface, or the like. Further, the short range wireless interface may also be wirelessly coupled to one or more radio frequency (RF)-enabled sensor devices to receive respective sensor data from the RF-enabled sensor devices.

In accordance with another embodiment of the invention, a method is provided for incorporating sensor functionality into mobile communication devices having a-host process and employing at least one removable memory card. The method involves facilitating access to the removable memory card by the host process using a digital interface, and storing sensor data from one or more sensor modules into a memory. The host process of the mobile communication device is coupled to the memory via the digital interface which is used by the host process to access the removable memory card. The sensor data may then be accessed from the memory by the host process via the digital interface.

According to more particular embodiments of such a method, storing sensor data may involve storing the sensor data into at least a first portion of the memory, where accessing the sensor data from the memory then involves accessing the sensor data from at least the first portion of the memory. In another embodiment of such a method, storing sensor data involves mapping sensor data from the memory into a defined portion of the removable memory card, where accessing the sensor data from the memory by the host process involves accessing the sensor data from the defined portion of the removable memory card. More particularly, mapping sensor data from the memory into a defined portion of the removable memory card may involve enabling a bridge to deliver the sensor data from sensor registers to the defined portion of the removable memory card. In such a case, accessing the sensor data from the memory may include enabling the bridge to deliver the sensor data from the defined portion of the removable memory card to the host process, and/or disabling the bridge to facilitate non-sensor-related memory transactions with the removable memory card from address locations not within the defined portion of the removable memory card.

According to still other embodiments of such a method, the sensor modules and memory may be removably coupled to the mobile communication device. For example, this may involve connecting the sensor modules and the memory to one or more connector slots on the mobile communication device. In another embodiment, the host process of the mobile communication device is disconnected from the memory, where the sensor data from the sensor modules is stored into the memory when the sensor modules and the memory are disconnected from the host process of the mobile communication device. In one embodiment storing the sensor data into the memory may be accomplished before coupling the host process of the mobile communication device to the memory (e.g., where the sensor module is operating as a stand-alone data logger), where in another embodiment the sensor data is stored into the memory after coupling the host process of the mobile communication device to the memory (e.g., where the memory is accessible to both the sensor functionality as well as the host process).

In accordance with another embodiment of the invention, a system is provided for providing sensor functionality to mobile devices capable of communicating over a mobile communications network The system includes modular sensor functionality including one or more sensors for gathering sensor data and a sensor memory to store the sensor data. The system includes a modular memory, and a mobile communication device having a master process for controlling communication between the master process and either or both of the modular sensor functionality and the module memory. A digital interface is provided for facilitating communication over a bus between the master process and the modular sensor functionality, and between the master process and the modular memory.

In accordance with another embodiment of the invention, a mobile device having a scalable sensor system, and capable of communicating wirelessly over a mobile communications network, is provided. The mobile device includes a processor configured to execute a host process, at least one modular card having sensor functionality to gather sensor data, and one or more slots for receiving the modular cards. A scalable digital interface is provided to couple the sensor functionality of the modular cards to the host process operating on the mobile device.

These and various other advantages and features of novelty which characterize the invention are pointed out with particularity in the claims annexed hereto and form a part hereof. However, for a better understanding of the invention, its advantages, and the objects obtained by its use, reference should be made to the drawings which form a further part hereof, and to accompanying descriptive matter, in which there are illustrated and described various representative embodiments of the present invention.

### BRIEF DESCRIPTION OF THE DRAWINGS

The invention is described in connection with the embodiments illustrated in the following diagrams.

FIG. 1 is a block diagram illustrating a representative environment in which the principles of the present invention may be applied;

FIG. 2 is a block diagram illustrating an exemplary memory architecture and corresponding bus arrangement in accordance with the present invention;

FIG. 3, including FIGS. 3A, 3B, and 3C, illustrates different representative modes for operating the sensor functionality in accordance with the present invention;

FIG. 4 is a block diagram illustrating one embodiment of a connection between sensor functionality and a host device;

FIGS. 5A and 5B illustrate more particular, representative embodiments of detachable sensor modules in accordance with the present invention;

FIG. 6 is a block diagram illustrating a logical scalable sensor system based on detachable sensor modules in accordance with the invention;

FIG. 7 is a diagram illustrating one embodiment of a physical scalable sensor system based on detachable sensor modules;

FIGS. 8A and 8B are diagrams illustrating representative stand-alone implementations of sensor systems in accordance with the present invention;

FIG. 9 is a block diagram of a representative embodiment of a remote sensor module in accordance with the present invention;

FIG. 10 is a block diagram illustrating an example of a bridge implementation in accordance with one embodiment of the present invention;

FIG. 11 illustrates a more particular embodiment of an MMC bridge implementation in accordance with the present invention;

FIG. 12 illustrates an MMC data interface implementation according to one embodiment of the present invention;

FIG. 13 illustrates an example of MMC card address space;

FIG. 14 is a flow diagram illustrating one embodiment for setting the base address register for an MMC card address space; and

FIG. 15 illustrates a representative mobile terminal computing system capable of carrying out operations in accordance with the invention.

### DETAILED DESCRIPTION OF THE INVENTION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

In the following description of the exemplary embodiment, reference is made to the accompanying drawings which form a part hereof, and in which is shown by way of illustration various embodiments in which the invention may be practiced. It is to be understood that other embodiments may be utilized, as structural and operational changes may be made without departing from the scope of the present invention.

Generally, the present invention provides a manner of removably connecting sensor functionality into mobile devices using a digital interface. One or more detachable sensor cards may be connected to a mobile device via the digital interface, and/or may be operational as a sensor data logging unit when disconnected or otherwise disassociated with a host device (e.g., mobile phone or other mobile computing and/or communications device). The present invention may be used for a wide variety of applications, such as games, fitness and/or sports applications, outdoor applications, and the like. The invention provides a versatile and scalable architecture on which different sensor applications can be built for ubiquitous communication applications.

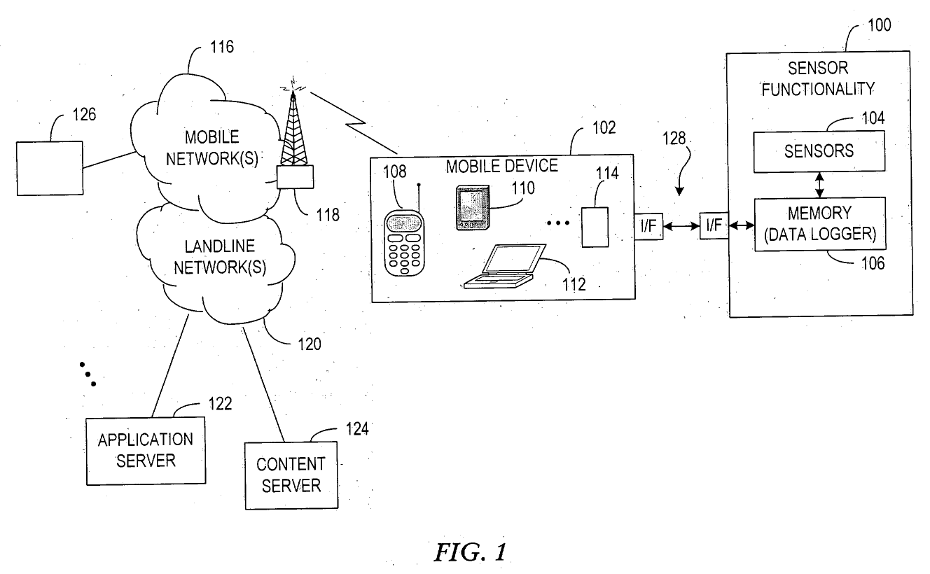

The present invention may be used in connection with any mobile device. Today's communication and networking technologies have allowed integration of an ever-increasing variety of mobile devices into the landline and wireless networks spanning the globe. In addition to the more traditional voice communication, mobile devices can communicate data, images, audio/video, and other information over wireless networks which in turn can communicate with landline networks. FIG. 1 is a block diagram illustrating a representative environment in which the principles of the present invention may be applied. The illustrated embodiment includes sensor functionality 100 associated with a mobile/wireless device 102. The sensor functionality 100 in accordance with the present invention may be used independently to log sensor 104 activity in a memory 106, and/or may be coupled to any number of mobile communication devices 102, such as a mobile/cellular phone 108, a personal digital assistant (PDA) 10, a notebook or laptop computer 112, or any other type of mobile terminal represented by device 114.

The mobile device 102 may communicate with one or more mobile operator networks 116. These mobile networks 116 may include, for example, a Global System for Mobile Communications (GSM) network and any associated networks such as a General Packet Radio System (GPRS) mobile communications network. As is known in the art, GPRS is a packet-switched service for GSM that mirrors the Internet model and enables seamless transition towards 3G (third generation) networks. GPRS thus provides actual packet radio access for mobile GSM and time-division multiple access (TDMA) users, and is ideal for Wireless Application Protocol (WAP) services. These mobile networks 116 represent other wireless networks and access technologies as well, such as Universal Mobile Telecommunications System (UMTS), Personal Communications Services (PCS), messaging technologies such as Short Messaging Service (SMS), Enhanced Messaging Service (EMS), and Multimedia Messaging Service (MMS), and the like.

In the illustrated embodiment, the mobile device 102 is associated with a cellular network such as a GSM network, where the mobile device 102 communicates wirelessly with the mobile networks 116 via base stations 118. The mobile networks 116 may communicate with one or more landline networks 120, which may include global area networks (GANs) such as the Internet. For example, the mobile networks 116 may communicate with landline networks 120 by way of Gateway GPRS Support Nodes (GGSN) (not shown), which serve as gateways between the GSM/GPRS network 116 and a packet switched public data network such as landline network 120. Network elements such as application and content servers 122, 124 may be accessible to the mobile device 102 by way of the mobile and landline networks 116, 120, while some network elements 126 may be directly accessible via the mobile network 116.

One embodiment of the invention describes a manner in which sensor functionality 100 is coupled to mobile devices 102 using a digital serial interface 128. Where such sensor functionality 100 is coupled to a mobile device 102, one particular embodiment of the invention involves the use of a digital interface 128 which is substantially the same type of interface as that used for external memory cards, such as a multimedia card (MMC) card or other removeable memory card. In accordance with another embodiment of the invention, the sensor functionality 100 may instead, or in addition, be used as a stand-alone device that is operational when detached from the host mobile device 102. In a stand-alone mode, the sensor functionality 100 gathers information from its sensors 104 which is stored in a memory or “data logger” 106. The sensor functionality 100 may be used in a variety of different applications utilizing sensors 104, as will be described more fully below.

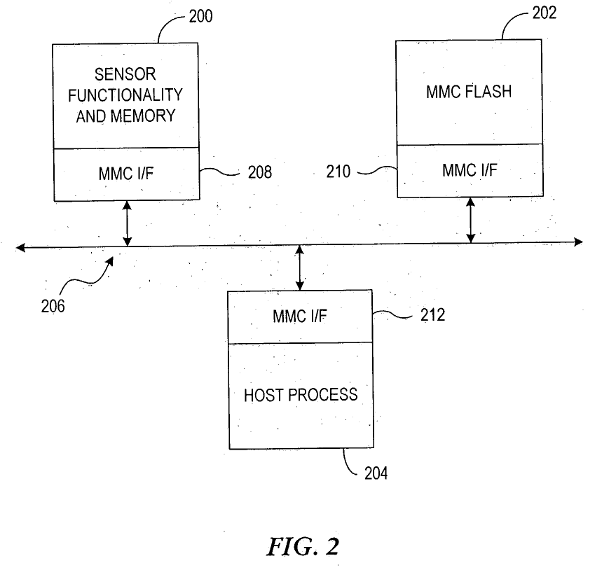

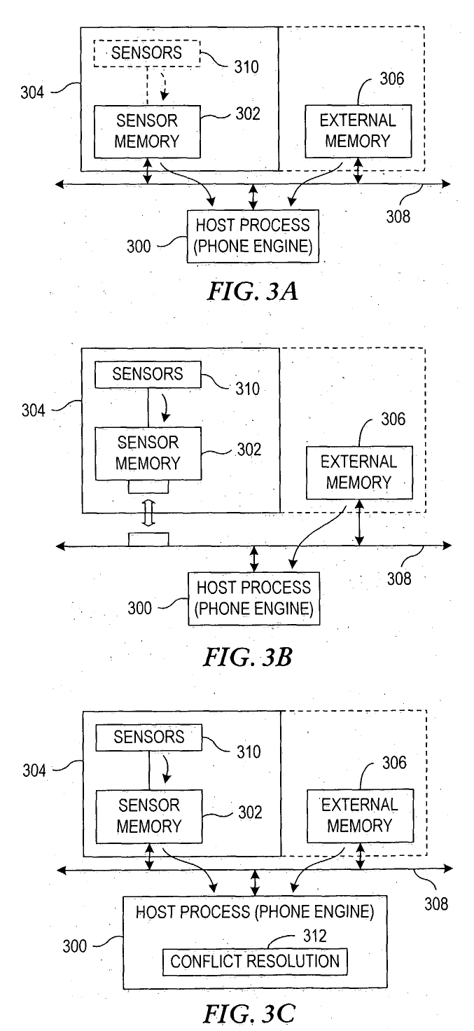

FIG. 2 is a block diagram illustrating an exemplary memory architecture and corresponding bus arrangement in accordance with the present invention. The illustrated system includes the sensor functionality 200 (including sensor memory), memory 202 such as MMC Flash memory, and the host process 204. A bus structure 206 supports the system where the sensor functionality 200 is coupled to the host process 204. In such an embodiment, each of the various modules including the sensor functionality 200, memory 202, and host process 204 includes an interface, illustrated as the MMC interfaces 208, 210, 212 respectively. Byway of these interfaces, both the sensor module 200 and the external flash memory 202 can be accessed by the host process 204 using the same bus interface 206, such as, for example, an MMC or Serial Peripheral Interface (SPI) bus. The system of FIG. 2 may be operated in a number of different modes, described in connection with FIG. 3 below.

FIG. 3, including FIGS. 3A, 3B, and 3C, illustrates different representative modes for operating the sensor functionality in accordance with the present invention. Like reference numbers are used for like elements in FIGS. 3A, 3B, and 3C for ease of description. FIG. 3A illustrates a first mode of operation. In this embodiment, similar to that shown in FIG. 2, the host process 300, such as a mobile phone engine, is operating as the master of the communication. Both the memory 302 of the sensor module 304 and the external memory 306 (e.g., flash memory) can be accessed by the master process 300 via the bus 308. The external memory 306 may be provided together with the sensor module 304, or alternatively may be provided on a separate MMC card. Information from one or more sensors 310 which has been stored in the sensor memory 302 is used by the master process 300 in the same way as data stored in the memory 306. More particularly, sensor. 310 data may be written into the sensor memory 302 and/or memory 306, and the host process 300 accesses the data from the sensor memory 302 and/or memory 306. Thus, the embodiment of FIG. 3A illustrates an operational mode where the sensor module 304 and the external memory 306 are accessed using the same bus interface 308, such as an MMC bus, SPI bus, or other similar bus.

FIG. 3B illustrates a second mode of operation, where the host process 300′ is detached from the sensors 310 and sensor memory 302 which may or may not include external memory 306. In this mode, the sensor module 304 operates as a stand-alone device, where sensor interface electronics (described more fully below) writes the sensor 310 data to the sensor memory 302, and/or to the external memory 306. In this embodiment, the system operates as a data logger for the sensor information. Additional embodiments of such a stand-alone embodiment are described more fully below.

FIG. 3C illustrates a third mode of operation. In this mode, the sensor module 304 is coupled to the host (master) process 300, but the sensor module 304 is still operating as a data logger. Therefore, the sensors 310 can store sensor information in the sensor memory 302 and/or external memory 306, and the sensor memory 302 and/or external memory 306 can be accessed by the host process 300. Thus, the sensor interface and the master process 300 can access the same memory. In such an embodiment, conflict resolution logic 312 is implemented to avoid read/write conflicts to the same memory. For example, one embodiment of the invention employs a bridging function that facilitates non-conflicting access to the memory 302/306 by both the host process 300 and the control functions' (not shown) associated with the sensor module 304. Such bridging functions are described more fully below. It should be recognized that additional modes of operation are also possible in accordance with the present invention, and the modes described in connection with FIGS. 3A, 3B, and 3C are provided as representative modes according to the present invention.

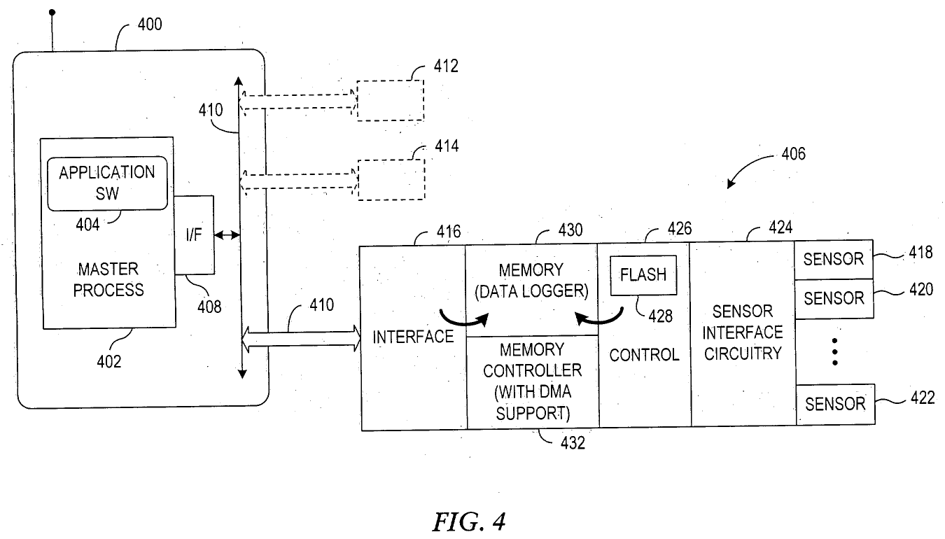

In accordance with the present invention, the digital interface used to communicate signals between the sensor functionality and the host device is the same digital interface used for external memory cards, such as MMC cards for example. In this manner, the sensor functionality may be added to mobile terminals by using existing (or future), supported and generic interfaces. FIG. 4 is a block diagram illustrating one embodiment of a connection between sensor functionality and a host device. The host device 400, such as a mobile phone, PDA or the like, includes a master process 402 which may include application software 404. The device 400 can communicate serially with other devices, such as the sensor module 406, via the serial intetface 408 and bus 410. Other devices 412, 414 can also be coupled the bus 41, which might include standard read-only, read/write, and input/output MMC cards or other fixed or removable modules.

The serial interface 408 may include any type of digital serial interface. Examples of interfaces that may be used in connection with the present invention include Universal Serial Bus (USB), Serial Peripheral Interface (SPI), RS-232, I²C, and MMC interfaces. An interface 416 is provided with the sensor module 406 to communicate with the host device 400. The interface may be an interface such as a serial interface, MMC interface, or the like. In this manner, information gathered by one or more sensors 418, 420, 422 can ultimately be received and processed by the master process 402.

The sensor interface circuitry 424 is coupled to the sensors to receive the sensor information. The sensor interface circuitry 424 may include physical interfaces and circuitry to receive and stabilize sensor 418, 420, 422 signals. Sensor signals are generally, but not necessarily, provided in analog form. The sensor interface circuitry 424 may therefore also include circuitry such as analog-to-digital converters (ADC), frequency counters, or other circuitry to process the sensor information. By way of a communication bus between the sensor interface circuitry 424 and the control circuitry 426, the sensor information can be internally processed by the control circuitry 426. The communication bus between the sensor interface circuitry 424 and the control circuitry 426 may be any parallel or serial bus, synchronous or asynchronous, and in one embodiment of the invention is a Universal Asynchronous Receiver-Transmitter (UART) or UART-like device that handles asynchronous serial communication.

The control circuit may be a microprocessor, microcontroller, reduced-instruction set computer (RISC), or other control/processing device. In one embodiment of the invention, the control circuitry 424 is implemented using a microcontroller, which includes some internal storage such as a Flash ROM 428 or other storage/memory. The Flash 428 may be used to store program instructions for use on the microcontroller, and may also be used to store information such as data and variables used to process sensor information. Alternatively, some or all of the control circuitry 424 may be implemented using dedicated logic circuitry.

The control circuitry 424 can effect data transfers to the external memory 430, which serves as a sensor data logger. In one embodiment, the memory 430 is implemented using Flash memory. A memory controller 432 may be used to facilitate the data transfers. For example, the memory controller 432 may include Direct Memory Access (DMA) support, thereby allowing DMA transfers between the control circuitry 424 and the memory 430. The memory controller 432 may also support DMA transfers between the memory 430 and the interface 416. It is noted that the master process 402 has access to the memory 430, but is not necessarily communicating with the controller 426 in one embodiment of the invention.

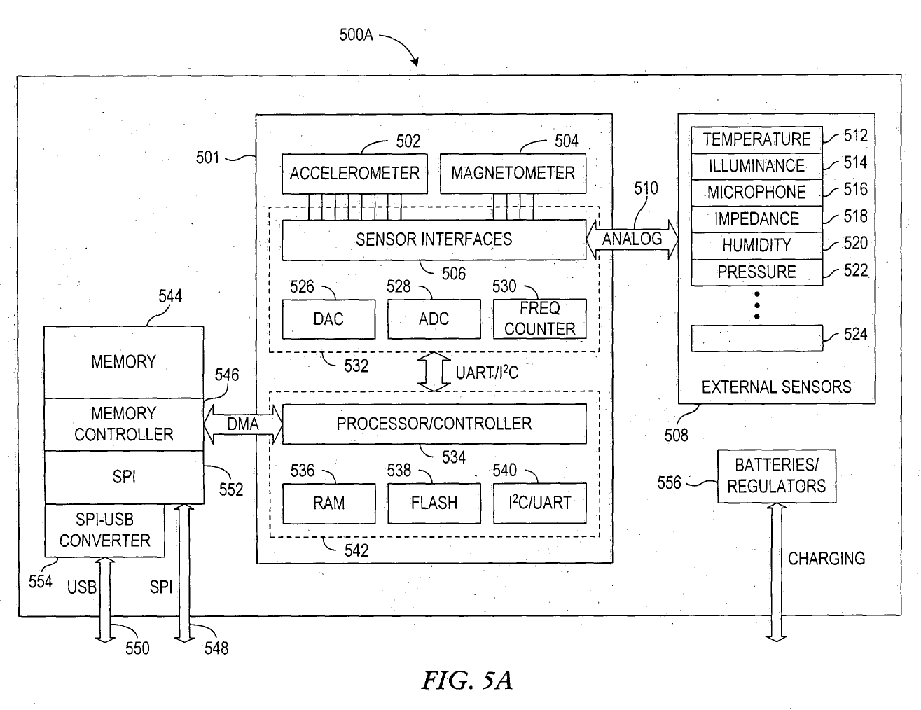

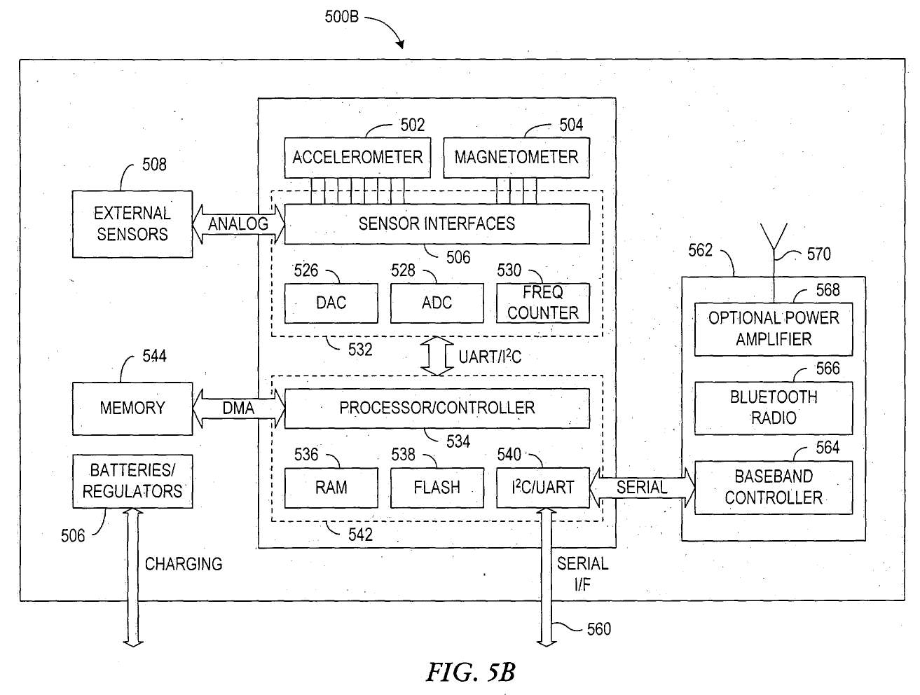

FIGS. 5A and 5B illustrate more particular, representative embodiments of detachable sensor modules in accordance with the present invention. FIG. 5A is a block diagram of a representative sensor module 500A that can be attached to a device such as a mobile phone or PDA. One section, shown as a multichip module 501, includes the various components discussed in connection with FIG. 4. More particularly, one or more internal sensors may be provided as part of the multichip module 501, such as the 3-axis accelerometer 502 and 3-axis magnetometer 504. The internal sensors are coupled to the sensor interface 506, as may one or more external sensors 508. An analog interface 510 may be implemented between the external sensors 508 and the sensor interface 506. Representative external sensors 508 may include sensors such as, for example, temperature 512, illuminance 514, audio (microphone 516), impedance 518, humidity 520, pressure 522, etc. Any type of other sensor 524 may be used. Further examples include sensors that can sense physiological conditions, such as heart rate, blood pressure, fat percentage, etc., which may be conveniently provided in a sport/fitness sensor package. Sensors may be internal or external to the multichip module 501, depending on the practicality of implementing it in chips or on the same PWB.

The sensor interface(s) 506 provides an interface between the various internal and/or external sensors, and circuitry such as digital-to-analog converters (DACs) 526, analog-to-digital converters (ADCs) 528, frequency counters 530, and the like. In one embodiment, sensing circuitry 506, 526, 528, and 520 are implemented in a common ASIC 532, but this need not be the case. The digital information may communicate with the processor/controller 534 via an interface such as, for example, a UART or I° C. interface or any other processor port. In one particular embodiment, the controller 534, RAM 536, Flash ROM 538, and UART/I²C circuitry 540 are associated with a functional cover controller 542, although this need not be the case. This may be the case where all or a portion of the sensor module 500A is embodied in a functional cover that can be physically situated to the housing of a mobile device.

As previously described, the controller 534 may execute memory access operations with the memory 544 and associated memory controller 546. For example, such memory access operations may be performed via DMA operations. Data may be transmitted via an interface, e.g., serial interfaces SPI 548 and/or USB 550 (or other serial or, if practical, parallel interface). The SPI module 552 represents SPI interface circuitry. Generally, an SPI interface is a 4-wire synchronous, inter-processor, master-slave interface. An SPI-to-USB converter 554 may be provided to facilitate connection to USB devices. Other interfaces may be used, including RS-232, and MMC which is described in greater detail below. In one embodiment, the sensor module 500A includes batteries and voltage regulators 556, although power may be provided by the host device power system.

FIG. 5B is a block diagram of one embodiment of the representative sensor module 500 that includes local/short range wireless capabilities. Like reference numbers are used for like elements in FIGS. 5A and 5B. In this embodiment, the detachable sensor module 500B can communicate directly with a host device via a serial interface 560 using the interface circuitry I²C/UART 540, or via a short range wireless technology such as Bluetooth, infrared (IR), etc. In the illustrated embodiment, a Bluetooth module 562 is provided. The module 562 includes a baseband controller 564 that communicates serially with the I²C/UART 540. A Bluetooth radio 566 or other similar RF device communicates information with the host device, and may also receive information from RF-enabled sensors. An optional power amplifier 568 may be used to amplify signals transmitted via antenna 570. In this manner, the sensor module 500B includes the capability to wirelessly communicate with the master process and/or remote sensors.

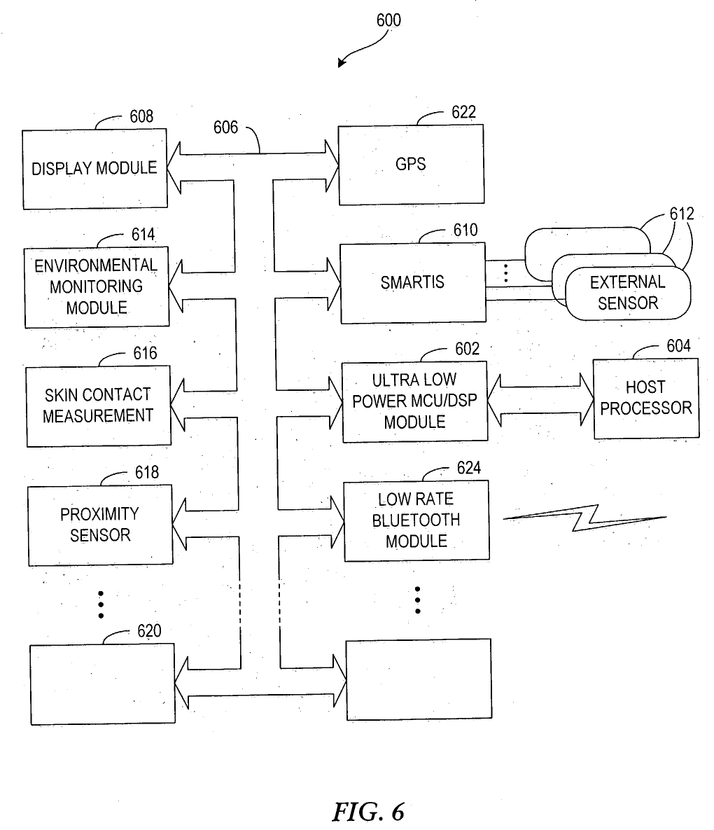

In accordance with the present invention, such detachable sensor modules enable the creation of scalable sensor systems. FIG. 6 is a block diagram illustrating a logical scalable sensor system based on detachable sensor modules. Different functionality can be added to a host device, such as a mobile phone or PDA, using the detachable modules. The exemplary scalable sensor system 600 of FIG. 6 includes an ultra low power Micro-Computer Unit (MCU)/Digital Signal Processing (DSP) module 602. MCUs generally refer to monolithic devices having functionality such as, for example, a control unit, arithmetic logic unit (ALU), RAM, and ROM. The MCU/DSP module 602 interfaces to a host processor 604, such as a mobile phone engine. Other hardware items may also be coupled to the bus 606 of the scalable architecture, such as the display module 608. Sensor functionality, shown as the SMARTIS module 610, may be implemented as previously described. The SMARTIS project aims, to provide interoperability of smart card system architectures. Internal sensors associated with such a module 610 include accelerators, light intensity sensors, magnetometers, etc. External sensors 612 may also be connected through the SMARTIS, module 610. Other pluggable sensors include, for example, the environmental monitoring module 614, the skin contact measurement module 616, the proximity sensor 618, or any other sensor module 620. Global Positioning System (GPS) module 622 and the low rate Bluetooth module 624 represent utility functionality that may be used in connection with, or independent of, the sensor functionality of the present invention. In accordance with the embodiment of FIG. 6, any of the sensor modules according to the present invention are independent of the other functionality in the system, and the different parts of the system 600 can interact with each other using well-defined digital interfaces.

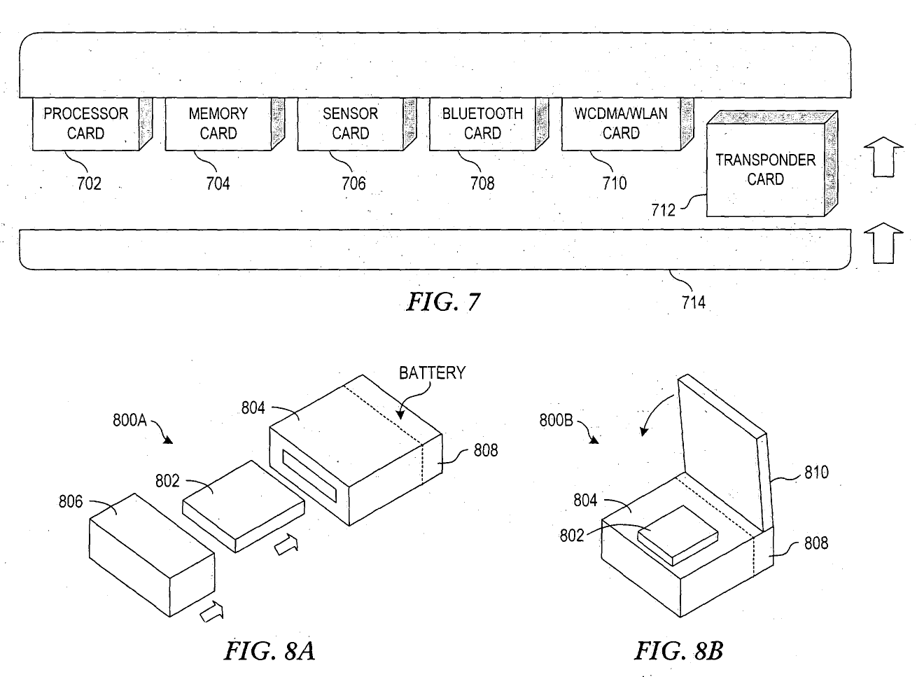

FIG. 7 is a diagram illustrating a physical scalable sensor system based on detachable sensor modules. A host device 700, such as a mobile phone, may be equipped with slots for receiving one or more modular cards 702, 704, 706, 708, 710, 712. The circuits associated with such module cards may be coupled in the manner described in connection with FIG. 6. For purposes of illustration and not of limitation, these modular cards may include a processor card 702, memory card 704, sensor card 706 as described in connection with the invention, a Bluetooth card 708, a WCDMA and/or WLAN card 710, and a transponder card 712 such as may be used in connection with Radio Frequency Identification (RFID) technology. In one embodiment, the cards 702-712 are inserted into available slots on the host device, and may be protected with an appropriate cover 714.

As previously indicated, the present invention also contemplates stand-alone sensor functionality, which is operable when not coupled to a host device. While the logical scalable sensor system of FIG. 6 may still be used, the physical sensor system is thus separate from the host/master device. FIG. 8A is a diagram illustrating a stand-alone implementation of a sensor system 800A in accordance with the present invention. The sensor card 802 may be provided in a separate receptacle or “holster,” which in the illustrated embodiment is implemented in multiple parts 804, 806. Since the sensor card 802 is not coupled to the master device to obtain operating power, a battery 808 or other power source may be provided with the receptacle base 804. In such an embodiment, the system functions as a data logger for the sensor information.

The stand-alone sensor module of FIG. 8A illustrates a two-piece receptacle that may be constructed to be substantially waterproof and otherwise resistant to weather conditions. Such a receptacle may further be provided with a display and/or audio output to provide status, results, etc. Other embodiments may include a one-piece receptacle, allowing the sensor card 802 to be removably fixed into the receptacle base 804. For example, an appropriate latching mechanism may be used to hold the sensor card 802 into the receptacle base 804 without the need for receptacle cover 806. Such an embodiment requires fewer parts, but may be less resistant to weather or fluids. In one embodiment of the invention, such a one-piece receptacle is provided and adapted such that it can receive a wristband, thus allowing a user to wear the sensor module similar to the manner in which a wristwatch is worn. Yet another embodiment of a sensor system may include a receptacle with a lid, as illustrated in FIG. 8B. The illustrated sensor system 800B includes the sensor card 802, the receptacle base 804, and the battery. A lid 810 may be closed over the receptacle base to protect the sensor card 802. Other receptacle implementations may be used in connection with the present invention.

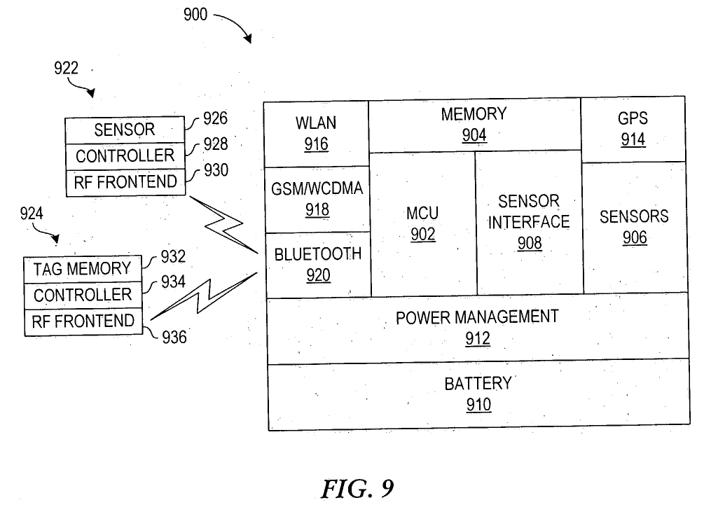

A variety of functionality can be provided in the stand-alone device, just as in the case of a host-detachable implementation. FIG. 9 is a block diagram of a representative embodiment of a remote sensor module 900 in accordance with the present invention. As in the host-detachable implementation, the sensor module 900 includes a controller, such as MCU 902, memory 904 (e.g., Flash), sensors 906, and a sensor interface 908. A battery(s) 910 and power management module 912 are provided to supply the remote sensor device with requisite operating power. Any number of other functionality previously described may be associated with the remote sensor module 900, such as a GPS module 914 for receiving positioning information, a Wireless Local Area Network (WLAN) module 916 for communicating with a wireless network, a Global System for Mobile communications (GSM)/Wideband Code Division Multiple Access (WCDMA) module 918 for cellular communications, a Bluetooth module 920 for facilitating short range wireless communications, etc. The Bluetooth module 920 may communicate with, for example, with remote devices 922, 924. For example, sensor device 922 may include one or more sensors 926, a controller 928, and an RF front-end 930 to communicate with the Bluetooth module 920. Device 924 may include a tag memory 932, controller 934, and again an RF front-end 936 to communicate with the Bluetooth module 920. In this manner, a remote sensing module 900 can be provided to serve as a sensor data logger, and to communicate to receive additional sensor information, and/or to forward sensor information to other devices or networks.

In accordance with the present invention, the various sensor functionality may be implemented in a removable chip or card, as illustrated in FIGS. 7, 8A, and 8B. While the present invention may be utilized with any removable or fixed circuit operable with a mobile device, one embodiment of the present invention involves the implementation of the sensor functionality in a removable card, such as a MultiMediaCard (MMC). An MMC refers to a data storage and communication media that exhibits high mobility and data throughput, while consuming relatively low power. In accordance with existing MMC standards, MMC communication is based on a serial bus having a particular communication protocol generally referred to herein as MMC mode. Such MMC cards may also offer an alternate communication protocol that is based on the SPI standard, or other standards. For purposes of explanation and not of limitation, various embodiments are described below of an MMC card architecture and bridging function in which aspects of the present invention may be implemented; however it will be apparent to those skilled in the art from the description provided herein that the present invention may similarly be implemented in other environments.

One basic concept of MMC cards involves the transfer of data using a minimum number of signals. Standard MMC communication signals include a clock (CLK) signal, a command (CMD) channel, and a data (DAT) channel. The CLK signal is used to synchronize data transfers across the bus. The CMD is a bidirectional command channel used for card initialization and data transfer commands. An open-drain operational mode is typically used for initialization, and a push-pull operational mode is typically used for command transfer. Commands are sent from the master (e.g., host process) to the card, and card “responses” are provided from the card(s) to the host. The DAT channel is also a bidirectional channel, which operates in push-pull mode. As is known in the art, push-pull refers to a logical interface operation mode where, for example, a complementary pair of transistors is used to actively drive the interface level to a logic high or logic low. MMCs can come in different categories such as Read-Only Memory (ROM), Read/Write (RW), and Input/Output (I/O).

Generally, MMCs include a set of information registers. The registers include a card identification number (CID), which is a unique number for the card. A relative card address (RCA) register is dynamically assigned during initialization, and identifies the local system address of the card. The card specific data (CSD) register provides information about the card operation conditions. The driver stage register (DSR) is optionally used to configure the card's output drivers, and the operation condition register (OCR) optionally provides a voltage profile for the card, to identify cards that do not support the full voltage range.

Currently, the MMC bus is a single master bus with a variable number of slaves. As will be described in greater detail below, one embodiment of the invention implements a new “multimaster” concept, thereby allowing for the possibility of other devices, such as the sensor module, to access the memory of the MMC card. Such an embodiment would involve, for example, a situation where the sensor module is attached to the master process, but the module is still operating as a data logger. In this mode, a bridge allows the sensor interface and the master process to access the same memory. The bridge in accordance with the present invention provides functionality to avoid conflicts between writing to and reading from the same memory.

The bridge functionality in accordance with the present invention can maintain hardware and software compatibility with an MMC memory card, and uses the MMC bridge concept to connect other busses or controllers/processors within the MMC card to the MMC bus. For example, in the case where a microcontroller associated with a sensor module is connected to the MMC bridge, this microcontroller may need to access the memory included in the MMC card, and the bridge functionality facilitates such memory access, while resolving possible conflicts on the MMC bus.

The MMC bridge architecture in accordance with the present invention includes at least two types, referred to herein as a standard bridge type and a multimaster bridge type. In one embodiment, the standard or multimaster bridge is connected between the memory die and the interface pads of the MMC card, where the MMC card is basically a printed wiring board (PWB) used to interconnect the various dies molded within a package. Using such an arrangement, the bridge can monitor and intercept exchanges on the MMC bus between the MMC host and the memory.

In accordance with the present invention, a sensor module (or other component) that is able to transmit and/or receive data is also coupled to the bridge. In the case of the standard bridge type, the bridge monitors the exchanges on the bus. When finding requests targeted to the sensor module, the bridge can redirect them to the sensor module, and vice-versa. The bridge also ensures otherwise normal operation between the host and the MMC. The implementation complexity of the standard bridge type is relatively low, as it does not require a full MMC controller implementation—rather, the MMC controller of the memory die can handle all of the MMC protocol. The standard bridge will implement a small subset of the MMC commands that allow access to the sensor module.

The bridge places the MMC memory in parallel with some other device, such as the sensor module, without interfering with the MMC memory. In one embodiment of the invention, the MMC host is equipped with a software module to recognize the “added value” MMC (e.g., memory plus sensor MMC), which allows the host to use both the memory and the sensor functionality. If the MMC host is not equipped with such a software module, the host will essentially disregard the sensor functionality and the memory/sensor MMC will behave just as a standard MMC memory card.

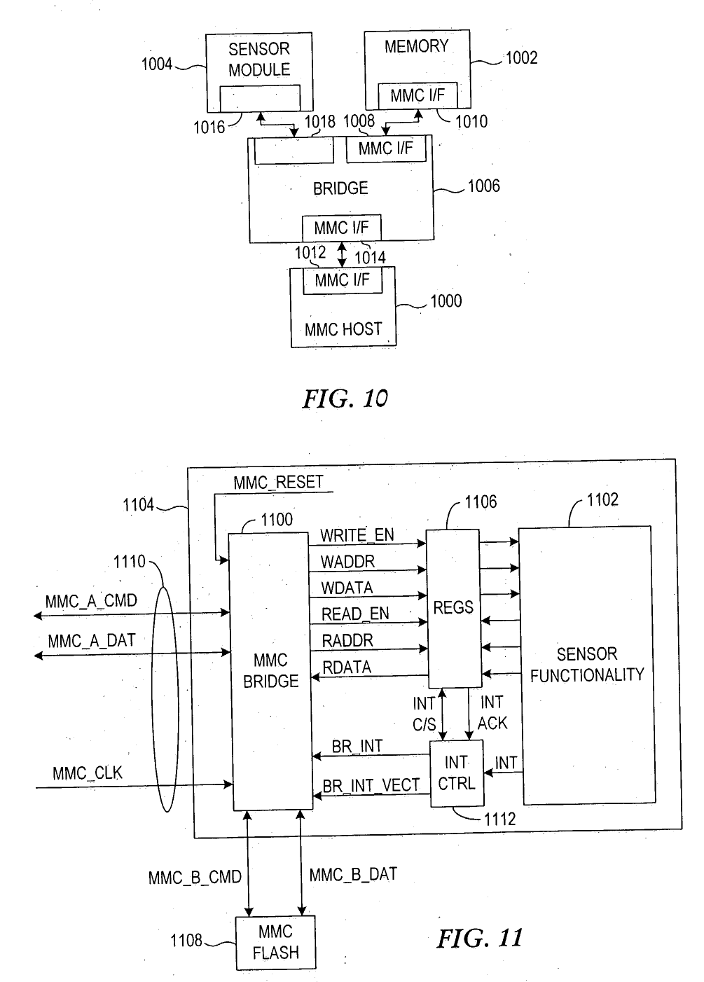

FIG. 10 is a block diagram illustrating an example of such a bridge implementation in accordance with the present invention. The illustrated embodiment includes an MMC host 1000, a memory 1002, and another component 1004 such as an Application-Specific Integrated Circuit (ASIC), microprocessor/microcontroller, etc. In one embodiment, the component 1004 represents a sensor module in accordance with the present invention. A bridge, the MMC bridge 1006 in this example, is logically coupled to each of the host 1000, memory 1002 and sensor module 1004. The bridge 1006 may communicate with the memory via MMC interfaces 1008, 1010, and may communicate with the host via MMC interfaces 1012, 1014. The interface 1016, 1018 may be any type of interface, depending on the type of component a104 that is present in the system.

FIG. 11 illustrates a more particular embodiment of an MMC bridge implementation in accordance with the present invention. In the illustrated embodiment, the MMC bridge 1100 and sensor functionality 1102 are provided in a common bridge block 1104. The bridge block 1104 provides an interface to internal registers 1106 and to the MMC card 1108 (e.g., FLASH/ROM) from the same MMC host interface 1110. Interrupts are sent from the sensor functionality 1102 to the interrupt control 1112, which in turn generates a bridge interrupt signal and an interrupt vector. The various signals and corresponding signal types, sizes, and functions of one embodiment are shown in Table 1 below:

TABLE 1

| Signal | Type | Size | Function |
|---|---|---|---|
| MMC_CLK | ext I | 1 | Clock signal for MMC bridge and registers |
| MMC_RESET | ext I | 1 | Reset signal for MMC bridge; MMC interface |
| | | | does not provide reset; reset generated internally. |
| MMC_A_CMD | ext IO | 1 | Host MMC command signal; during card |
| | | | identification, IO type is open drain (open |
| | | | collector), otherwise push-pull. |
| MMC_A_DAT | ext IO | 1 | Host MMC data signal |
| MMC_B_CMD | ext IO | 1 | Card MMC command signal; during card |
| | | | identification, IO type is open drain (open |
| | | | collector), otherwise push-pull. |
| MMC_B_DAT | ext IO | 1 | Card MMC data signal |
| DISCONNECT_DAT | int O | 1 | Disconnect data signal from MMC card to send |
| | | | bridge internal data. |
| DISCONNECT_CMD | int O | 1 | Disconnect command signal between MMC host |
| | | | and MMC card |
| WRITE_EN | int O | 1 | Write enable signal from MMC bridge to registers |
| WADDR | int O | 8 | Write address to registers |
| WDATA | int O | 8 | Write data to registers |
| READ_EN | int O | 1 | Read enable signal to registers; used as an |
| | | | acknowledgment that specific register has been |
| | | | read, if such functionality is required |
| RADDR | int O | 8 | Read address to registers |
| RDATA | int I | 8 | Read data from registers |
| BR_INT | int I | 1 | Generate interrupt to MMC interface; pulse to |
| | | | generate interrupt to MMC host. |
| BR_INT_VECT | int I | 16 | Interrupt vector containing information about |
| | | | interrupt source. This vector is sent in the |
| | | | response token sent to MMC interface when |
| | | | bridge is in IRQ state and bridge interrupt is |
| | | | activated from backend. |

Various signals from Table 1 are shown in FIG. 11. The “type” field represents the type of signal, such as an external input (ext I), external input/output (ext IO), internal output (int O), and internal input (int I). The “size” field represents the bit width of the signal.

As will be described in greater detail, the internal registers 1106 are mapped to a specific location or “window” in the MMC card 1108 address space. The base address of the internal register window can be programmed. When the system is powered up, only the base address configuration register is visible at the fixed location which is used to write a new base address for the internal register that is suitable for the system. When the programmable base address is configured, the fixed base address is hidden, and can be used as a normal MMC card 1108 address. In this manner, all the write operations to the internal register window are presented to both the internal registers 1106 and the MMC card 1108, and the MMC card 1108 generates correct response. Further, during read access to the internal register window, the bridge 1100 replaces read data from the MMC card 1108 with internal register 1106 read data. In one embodiment, the bridge 1100 includes the same state machine functionality that is implemented within MMC card 1108 to comply with the MMC protocol specification.

Most of the time the DISCONNECT CMD signal is inactive and the MMC host and the MMC Card are connected, the bridge will remain hidden from the MMC bus. The MMC bridge monitors commands and responses seen on the MMC bus in order to follow the state changes of the MMC card. During a card identification phase after a SET CARD RELATIVE ADDR command has been detected on the MMC bus the bridge will disconnect card and host from each other. If now a response related to that command is detected coming from the card behind the bridge (MMC_B_CMD), the bridge will know that that address belongs to a card behind the bridge or the bridge itself. If the response is detected from the host side of the bus (MMC_A_CMD), the address will not be used by the bridge. After a response has been received, the host and card are connected to each other again. The bridge will set the MMC_CMD signal only when the host and card are disconnected or when it is responding to the FAST IO or SET IRQ (interrupt mode) command.

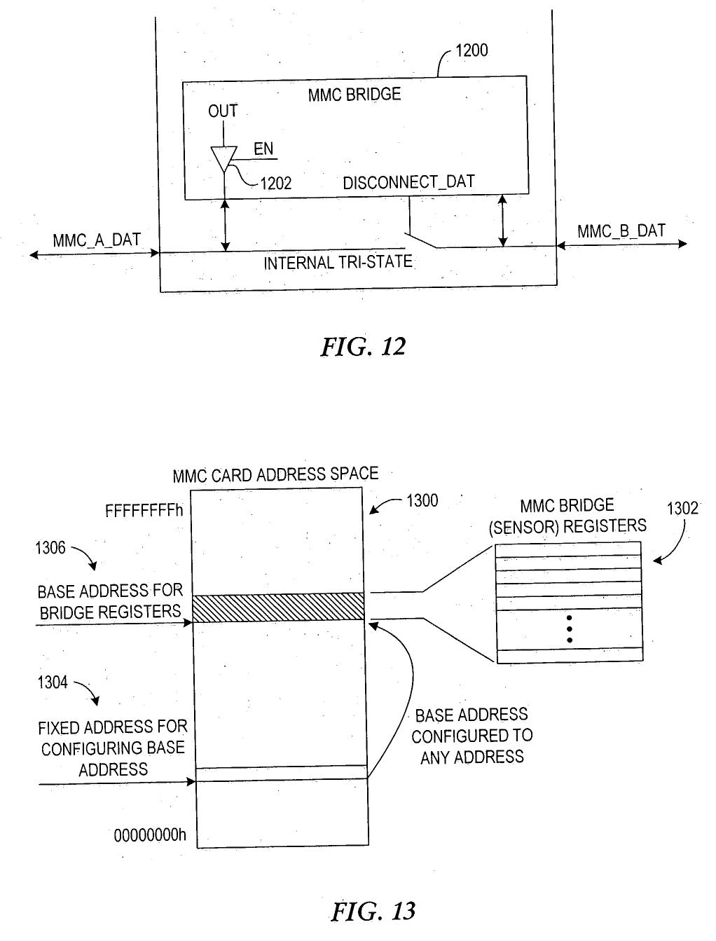

One embodiment of an MMC data interface implementation is illustrated in FIG. 12. The MMC bridge 1200 includes an internal tri-state condition. When internal register data is to be sent, the buffer 1202 is enabled (EN), the DISCONNECT_DAT signal disconnects the MMC_B DAT signal from the MMC card, and the signal(s) to be output (OUT) is sent to the host via the MMC_A_DAT signal. In the illustrated embodiment, the DISCONNECT_DAT signal is thus active when data is read from the internal registers. Alternatively, the DISCONNECT_DAT signal is inactive when data is read from or written to the MMC card via the MMC_B_DAT signal. This implementation reduces functional complexity inside the bridge 1200 and allows the MMC card to implement the appropriate response protocol for the data signal.

A number of MMC commands are supported by the MMC bridge. These commands are handled by the MMC bridge and by the MMC card. Table 2 below illustrates representative commands that may be actively supported by the MMC bridge. Other standard MMC commands may be passively supported by the MMC bridge by allowing the MMC card to handle them transparently.

TABLE 2

| Command | Use For Command Inside Bridge |
|---|---|
| cmd00_go_idle_state | State transition |
| cmd01_send_op_cond | State transition |
| cmd02_all_send_cid | State transition |
| cmd03_set_relative_addr | Bridge identification |
| | Setting relative address for bridge |
| | State transition |
| cmd07_select_deselect_card | Bridge selection |
| | State transition |
| cmd15_go_inactive_state | State transition |
| cmd16_set_blocklen | Setting blocklength for write and read access to and from bridge |
| cmd17_read_single_block | Reading bridge internal registers |
| cmd39_fast_io | Alternative way of writing and reading bridge registers |
| | This functionality can be enabled/disabled |
| | Bridge responds to fast I/O command if this functionality is |
| | enabled |
| cmd24_write_block | Writing bridge internal registers |
| | Bridge generates response if MMC card does not support this |
| | command |
| cmd40_go_irq_state | State transition |
| | Sending bridge interrupt response when bridge is in this state |
| | and BRIDGE_INT is asserted |

A software register interface is also provided with the MMC bridge. As is known in the MMC art, each standard MMC card includes a set of information registers as previously described, which include the CID, RCA, DSR, CSD, and OCR registers. In accordance with one embodiment of the invention, certain standard MMC registers are implemented within the MMC bridge. Table 3 illustrates which MMC registers are implemented in one embodiment of the bridge configuration, and how they are implemented.

TABLE 3

| Reg | Description | Bridge implementation |
|---|---|---|
| OCR | operating conditions | Not implemented inside bridge |
| CID | card identification | Not implemented inside bridge |
| CSD | card specific data | Not implemented inside bridge |
| RCA | relative card address | Implemented; used as a bridge |
| | | address; same as RCA for card |
| | | located behind bridge; power-on |
| | | default value of 0x0001 |
| DSR | driver stage register | Not implemented; specified |
| | | to be optional in MMC specification |

The MMC bridge registers are now described. FIG. 13 illustrates an example of the MMC card address space 1300, ranging from address 00000000h to FFFFFFFFh for purposes of example. Internal bridge registers 1302 are mapped to a specific location (i.e., window) on the MMC card address space 1300. In one embodiment of the invention, the bridge register address space 1302 includes bridge control/status registers in the first eight bytes of bridge register address space 1302, and includes application registers in the remaining bytes. Table 4 illustrates an example of bridge control/status registers used in one embodiment of the invention:

TABLE 4

| Name | Type | Addr | Bits | Description |
|---|---|---|---|---|
| MMC_BRIDGE_BAR_3 | rw | 00 h | 7:0 | MMC BRIDGE BASE ADDRESS for internal |
| | | | | registers & registers behind bridge, bits 31 . . . 24 |
| MMC_BRIDGE_BAR_2 | rw | 01 h | 7:0 | MMC BRIDGE BASE ADDRESS for internal |
| | | | | registers & registers behind bridge, bits 23 . . . 16 |
| MMC_BRIDGE_BAR_1 | rw | 02 h | 7:0 | MMC BRIDGE BASE ADDRESS for internal |
| | | | | registers & registers behind bridge, bits 15 . . . 8 |
| MMC_BRIDGE_BAR_0 | rw | 03 h | 7:0 | MMC BRIDGE BASE ADDRESS for internal |
| | | | | registers & registers behind bridge, bits 7 . . . 0 |
| MMC_CONTROL | w | 04 h | | MMC bridge control |
| | | | 7 | Disable FAST IO command |
| | | | | 1 = FAST IO command is disabled |
| | | | | 0 = FAST IO command is enabled (default) |
| | | | 6:0 | Force reconfiguration of programmable |
| | | | | address base by writing, for example, |
| | | | | “1010101” here. |
| MMC_STATUS_1 | r | 05 h | | MMC BRIDGE STATUS 1 |
| | | | 7:5 | Unused bits |
| | | | 4 | Bridge programmable base address |
| | | | | configuration |
| | | | | 1 = Programmable base address has been |
| | | | | configured |
| | | | | 0 = Programmable base address has not been |
| | | | | configured |
| | | | 3:0 | Bridge state |
| MMC_STATUS_2 | r | 06 h | | MMC BRIDGE STATUS 2 |
| | | | 7:6 | Unused bits |
| | | | 5 | Programmable base address configuration |
| | | | | error detected |
| | | | 4 | Bridge has detected CRC error in DAT signal |
| | | | | from host |
| | | | 3 | Card has detected CRC error in DAT signal |
| | | | | from bridge |
| | | | 2 | Response timeout error |
| | | | 1 | Bridge has detected response CRC error |
| | | | 0 | Bridge has detected command CRC error |
| SENSOR_ID | r | 07 h | 7:0 | ID NUMBER of function connected to bridge |

The type of control/status register includes read (r), write (w), and read/write (rw). The MMC_BRIDGE_BAR_X registers, described more fully below, represent the MMC bridge base address for the internal registers. The MMC_STATUS_{—}1 and MMC_STATUS_{—}2 desired status, such as whether or not the programmed base address has been configured, whether CRC or programmable base address configuration errors have been detected, etc. Another example of a status field is the bridge state (e.g., bits 3:0 of MMC_STATUS_{—}1), which can provide status such as whether the bridge state is idle, ready, standby, read, write, interrupt request, unknown state, etc. In one embodiment, the MMC_STATUS_{—}1 byte is cleared prior to configuration (described more fully below), and then the configuration process is performed. Bits 4:0 are then checked to determine if the programmable base address has been configured. Finally, the SENSOR_ID byte provides an identification number of the function connected to the bridge.

As previously indicated, the bridge register address space 1302 includes application registers in remaining bytes. Table 5 illustrates an example of bridge application registers used in one embodiment of the invention:

TABLE 5

| Name | Type | Addr | Bits | Description |
|---|---|---|---|---|
| SENSOR_REG_0 | rw | 08 h | 7:0 | Application register 0 |
| SENSOR_REG_1 | rw | 09 h | 7:0 | Application register 1 |
| . . . | rw | . . . | . . . | . . . |
| SENSOR_REG_N | rw | FFh | 7:0 | Application register n |
| | | | | Note: Bridge address |
| | | | | space can be larger than 256 |
| | | | | address or FFh |

These registers provide application-specific sensor registers depending on the particular sensor(s) application. In one embodiment, the application-specific register address space begins at address 08h and ends at an address specified for each application.

Registers may be written using commands such as those identified in Table 2. For example, the cmd24_write_block command may be used to write a block of data.

There are various mechanisms that may be used to access the sensor card functionality and information. Again, the mechanisms are described in terms of the MMC specification to illustrate one manner of making the MMC card with the bridge implementation of the present invention compatible with the MMC specification. However, these principles may be analogously applied to other interface arrangements.

The above sets the stage for a memory mapped access mechanism to access the sensor card functionality and information. In a memory mapped approach, only mandatory commands from the MMC specification are used so that every MMC host will be able to access the shadow device in this fashion. Using this approach, a set of addresses for the bridge registers 1302 is reserved in the MMC memory address space 1300. The relative card address (RCA) may be set wit the cmd03_set_relative_addr command shown in Table 2. The bridge detects the relative card address to be used by the card behind the bridge and by the bridge itself by detecting which card responds to the cmd03 set_relative_addr command. In one embodiment, if the card responding to that command is located behind the bridge, then the bridge will use the same address (RCA). After setting RCA the bridge and the card will be selected and deselected simultaneously with the cmd07_select_deselect_card command.

Read and write commands to the bridge are decoded by using a bridge base address. A fixed bridge base address 1304 has a preset default value after reset in one embodiment of the invention, and is used for setting the programmed bridge base address 1306. The fixed bridge base address 1304 is selected such that it does not introduce any conflicts with the file system used on the MMC memory. This can be accomplished in various manners. For example, in MMC memory, the most widely used file system is the File Allocation Table (FAT) system. The FAT file system provides for the possibility of defining some reserved sectors in the memory, which will be completely hidden for the file system. For this reason these are referred to as hidden sectors in the FAT system. In practice, the MMC card will be formatted in a conventional manner, but with at least one hidden sector. This sector will be then the set of addresses giving access to the sensor module.

Another possibility is to use a special “system” file at a special location on the memory, such as a file located in the last few sectors of the memory. This file would be recognized as a “system” file by the operating system, and consequently its position would not be alterable by the file system. Whether using hidden sectors or a system file, the situation for the bridge is the same—it will have to respond to a set of given addresses when accesses have to be directed to the sensor module. Because MMC memories come in various sizes, there is no practical way to have a fixed sector (or a set of fixed sectors) for every memory size, and a mechanism should be defined that will program the bridge with the correct set of addresses used to access it. Here again, the structure of the file system will help. In FAT systems, four partitions are defined, where some operating systems use only the first two partitions. The structure in the file system may then be used, which defines the two unused partitions. But a mechanism that is not dependent on the use of two or four partitions by the operating system is still needed. This can be solved as follows. Each partition is defined by a structure, which fits in one sector. The two last bytes of this sector are always 0x55h and 0xAAh. The last two bytes of the two unused partitions may then be used to specify to the bridge the 32-bit linear base address of the sensor module. After overwriting these bytes in this manner, the software used to configure the bridge is written back to the correct value.

To avoid any accidental configuration of this base address, a specific procedure may be followed for the configuration. For example, the low 16 bits of the base address is written at the last two bytes of the sector where the structure defining the third partition is located, referred to herein as LOW_ADDR_BASE. Then, the previous value, which is 0x55h, 0xAAh is written back to that location. The high 16 bits of the base address is then written to the last two bytes of the sector where the structure defining the fourth partition is located, referred to herein as HIGH_ADDR_BASE. Then the previous value of 0x55, 0×AA is written back to that location.

Another manner of selecting the fixed bridge base address 1304 such that it does not introduce any conflicts with the file system used on the MMC memory is using application (ACMD) commands. More particularly, this method uses some optional commands of the MMC specification, however only MMC hosts implementing such commands would be able to access the sensor module using this method. Using this method, some application-specific commands are sent to the bridge. When one of these commands is sent by the host, the MMC memory will receive this command as well, so care should be taken to avoid any potential conflicts where the memory uses the same ACMDs.

Another representative manner of selecting the fixed bridge base address 1304 such that it does not introduce any conflicts with the file system used on the MMC memory is using a Fast I/O command. As in the case of using ACMDs, this method uses some optional commands of the MMC specification, and only MMC hosts implementing such commands would be able to access the sensor module using such a method. MMC memories do not use the Fast I/O command, so there is no risk of conflicts. Currently, this command provides the possibility to read and write to a set of 128 registers, where all or part of these registers can be used to access the sensor module. If the MMC host implements such commands, this provides for a highly viable and relatively simple solution.

Returning to FIG. 13, the fixed bridge base address 1304 has a preset default value after reset, and is used for setting the programmed bridge base address 1306. In writing to the fixed base address 1304 in accordance with one embodiment, the blocklength is set to four or larger with the cmd16_set_blocklen command shown in Table 2. The cmd24 write_block command may be used to write this register, shown as addresses 00h through 03h in Table 4.

The programmed bridge base address 1306 represents the start address of the memory address space 1300 that is reserved for the sensor interface read and write registers. In the embodiment, the length of this memory window 1302 is 256 bytes, although any desired length and/or width may be utilized. This sensor interface window 1302 becomes visible once the programmed bridge base address 1306 has been set.

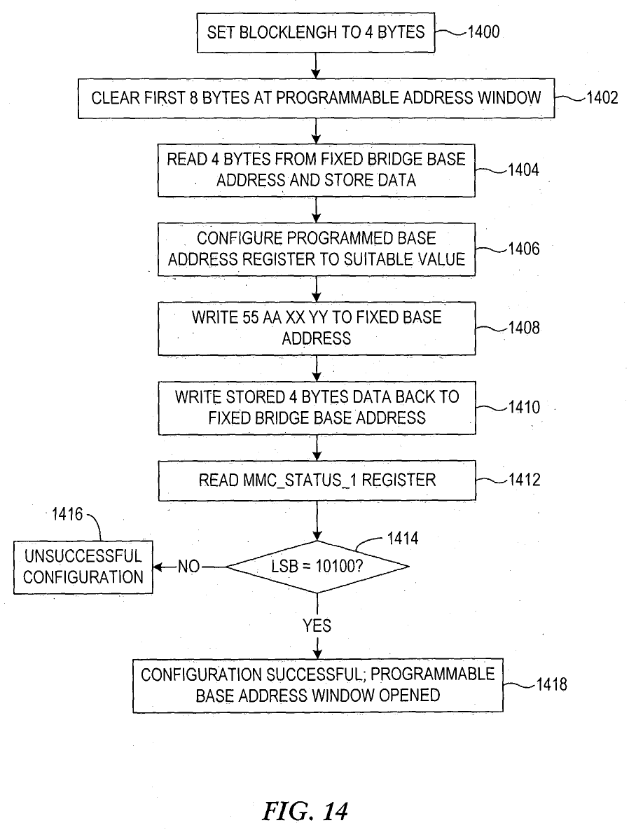

In one embodiment of the invention, the base address register (addresses 00h through 03h in Table 4) is set as shown in the flow diagram of FIG. 14. In this embodiment, the blocklength is set to four, as shown at operation 1400. The first eight bytes at the programmable address window are cleared 1402, e.g., written to zeroes. These first eight bytes represent the MMC_BRIDGE_BAR_{—}0 previously shown in Table 4. This is performed to later detect whether the bridge is present. Then, four bytes are read 1404 from the fixed bridge base address, and the data is stored. This data is read from the MMC card rather than the bridge itself, since the bridge does not respond to read accesses from the fixed bridge base address. Using, for example, a single block write command to the fixed base address, the programmed base address register is configured 1406 to any value found suitable from the system point of view. The value 55h AAh XXh YYh is then written 1408 to the fixed base address, where XXh is the third byte read at operation 1404 and YYh is the fourth byte read at operation 1404. Writing 55h and AAh at this point activates the programmable base address and deactivates the fixed base address.

The four bytes that were stored at operation 1404 are written 1410 back to the fixed bridge base address. This data will be written to the MMC card and will not change the programmed base address inside the bridge, since the bridge has been configured at operation 1406. In the illustrated embodiment, configuration of the programmable bridge base address is allowed only once after reset, and the rest of the write operations to the fixed bridge base address will only change the data located in the MMC card. This operation is only needed in addition to operation 1408 if the first two bytes at the fixed base address are different from 55h AAh.

At this point, the MMC_STATUS_{—}1 register (see Table 4) is read 1412 from the programmable base address window. If, as determined at decision operation 1414, the least significant bits (LSB) does not read 10100, the configuration is unsuccessful as shown at operation 1416. Otherwise, this indicates at bit-4 that the programmable base address has been configured successfully, and the programmable base address window has been opened as shown at operation 1418.

Using a bridge as described above further provides for the possibility of the sensor module to access the memory of the MMC card. This is referred to herein as multimastering, since both the MMC host and the sensor module can operate as a master using a bridge in accordance with the present invention. In this case, the bridge is more complex, as it takes into account the possible simultaneous access from the sensor module and the MMC host to the memory device. Even with the addition of this multimastering capability, the MMC card is seen as a standard MMC card, as the multimaster nature provided by adding the bridge to the MMC card will be completely transparent to the MMC host.

There are various manners to define or use the multimastering capability added by the bridge. In one embodiment, the MMC card is in the mobile terminal, so both the MMC host and the sensor module are active. In this case both could attempt to access the memory at the same time. The bridge can handle this situation without the need for additional software. More particularly, the bridge can indicate to the MMC host that the bus is busy but will be released soon. There are various manners of providing such an indication. For example, one manner is to use the response that the MMC card has to send after each command to indicate MMC card status. The status code is a 32-bit word with two bits reserved for application-specific commands. One of these bits may thus be used as a busy state. However, this will lead to a small modification in the MMC host implementation in the mobile terminal. First of all, the mobile terminal takes this busy bit only for responses coming from a MMC card with a MMC bridge, and ignore this busy bit for a “normal” MMC card with no MMC bridge. Second, the MMC host will buffer and delay any access requested by the MMC host until the bus is free again. In this embodiment, it is advantageous to configure the sensor module to operate in a way that reduces the number of accesses to the memory and shortens the length of each access.

In another embodiment, some additional software may be used. This software will simply freeze the MMC host, freeing the bus for a given amount of time. This software will send a command to the sensor module to grant it access to the memory card. When the sensor module has finished accessing the memory, the software in the host (e.g., mobile terminal) will release the MMC host to access the bus again. In this embodiment, there may be no need to change the MMC host implementation in the mobile terminal, but at least a small amount of additional software is utilized. This software will simply coordinate the access to the MMC bus, and give the rights to the sensor module to access the bus. Meanwhile, this software will prevent the MMC host from issuing any requests on the MMC bus.

In yet another embodiment, the MMC card is not in the mobile terminal, but nonetheless is powered up in any manner such as by a battery in the stand-alone configuration. In this manner, only the sensor module has access to the MMC memory, since the MMC host is not present on the bus at all. This is the simplest case, as long as a mechanism is used to detect if the MMC card is installed in a mobile terminal or simply powered up by some other device without a MMC host. This can be done, for example, by using device identifications or the like. The sensor device can access the MMC memory using MMC mode, SPI mode, or other analogous mode.

The host-detachable and stand-alone sensor systems in accordance with the present invention may be used for a variety of purposes. A few representative examples are described herein, although it will be apparent to those skilled in the art from the description provided herein that other uses are equally applicable in accordance with the present invention. Representative examples of sensor categories that may be used in connection with the present invention include micro-mechanical sensors, actuators, biometric identification, etc. For example, such sensors and devices may include linear and angular accelerometers, tilt sensors, gyroscopes, pressure sensors, temperature sensors, humidity sensors, magnetometers, light sensors, fingerprint identification sensors, skin contact sensors (e.g., heart rate, blood pressure, fat percentage), compasses, and the like.

Different sensors and accompanying features may be provided as specialized sensor card packages. A first example includes a “sports” or “fitness” card. For many people, fitness plays an important role in the person's day-to-day life. Using a fitness card, the user can have control over things such as calories consumed, distance walked during the day/week/etc., step length, counted steps, heart rate, temperature, and the like. A fitness card can come equipped with the appropriate sensors and accompanying memory to monitor and record such data. The fitness card may be provided as a detachable unit used in connection with an existing mobile terminal, such as a mobile phone, PDA, etc., or may be used as a stand-alone device as previously described. For example, a mobile phone adapted to receive such a fitness card (referred to herein as a “media phone”) may receive the fitness card. The user can view fitness status via the media phone when the fitness card is inserted, such as presenting a daily/weekly/etc. activity diary via a graphical user interface (GUI). The interface can also be used to allow the user to customize the level of detail desired. Such a fitness card may be used by professional athletes, health and fitness enthusiasts, as well as ordinary people wanting to live a healthy lifestyle.

In one embodiment of the invention, the user of such a fitness card uses the fitness card in a stand-alone mode while gathering fitness data. For example, when it is time to exercise, the user can place the fitness card into a fitness receptacle, such as previously described in connection with FIGS. 8A and/or 8B. The fitness receptacle can then be placed into a belt strapped to the user, clipped or otherwise fastened to clothing, wrapped to the wrist or ankle, worn as a necklace, placed into the user's pocket, etc. When the user has completed the exercise or other activity where fitness data was collected, the user may want to view the collected data. Where the receptacle is not equipped with user interface features to allow such viewing, the user may choose to remove the fitness card from the receptacle, and place the fitness card into his/her media phone or other device to view the results. While in the media phone, the fitness card can continue to monitor activity, but also allows the collected data to be presented to the user. In one embodiment, the media phone and/or the stand-alone device may include contact areas on the surface, such as a “functional cover,” to enable the user to measure and store blood pressure, fat percentage and the like, to see the positive effect of the training program by comparing to previous data.

Another example of a specialized sensor card package is an “outdoor” card. An outdoor enthusiast may have hobbies such as climbing and skiing. Using his/her media phone or other device equipped to receive the outdoor card, the user can surf to club web pages, such as a climber club web page, to view his/her own (and other members') results or statistics during a particular time period or for a certain event(s). When the user is engaged in a climb or other activity, the outdoor card may be placed in a wrist holder or otherwise attached to the user to log activity and/or provide the user with information during the activity. For example, a compass may be provided with the outdoor card, thereby allowing the user to use the media phone or stand-alone device as a compass. A GPS module may also be provided with the outdoor card, which further enables the user to identify desired destinations, pinpoint his/her location, etc. The outdoor card may be equipped with an altimeter to present the user's current altitude, which can be stored as an altitude profile throughout the activity.

Sensor cards in connection with the present invention may also be used in a more passive data collection mode. For example, a “house guard” sensor package may include sensors such as light detectors, motion detectors, a microphone, temperature sensors, etc. The house guard sensor package may be inserted into the user's media phone, stand-alone device, or the like, and positioned in a suitable place within a home or other location to monitor for unauthorized entry, to verify timed lighting scenarios, to monitor for heat loss, etc. As can be seen, any number of such “packages” may be contrived in connection with the present invention.

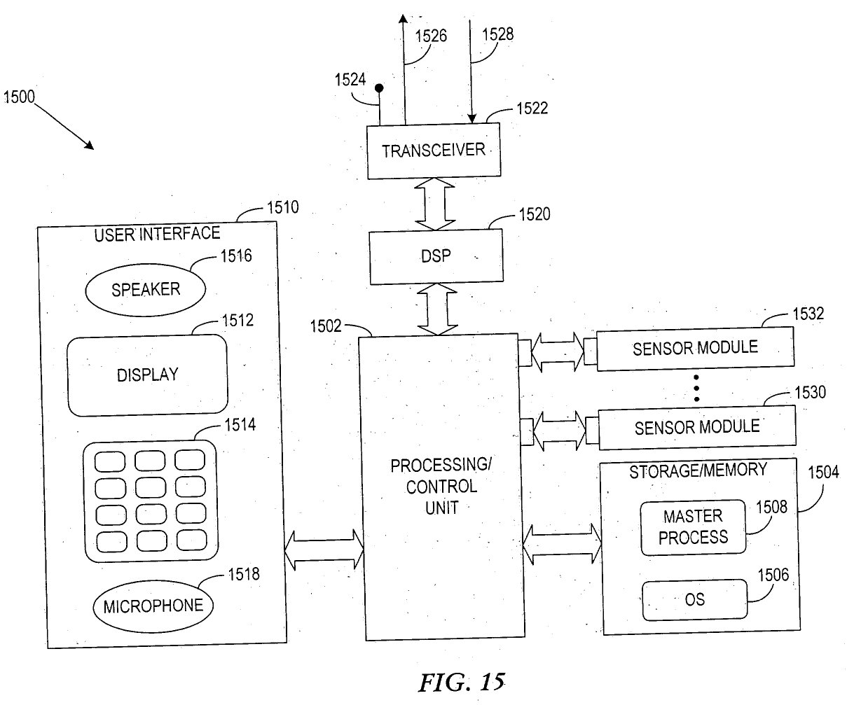

When used as a detachable module, the sensor functionality in accordance with the present invention may be used with a variety of types of mobile terminals, including wireless/cellular telephones, personal digital assistants (PDAs), or other wireless handsets. The mobile terminals utilize computing systems to control and manage the conventional device activity as well as the functionality provided by the present invention. Hardware, firmware, software or a combination thereof may be used to perform the functions and operations described herein. An example of a representative mobile terminal computing system capable of carrying out operations in accordance with the invention is illustrated in FIG. 15.

The exemplary mobile terminal 1500 suitable for receiving detachable sensor modules in accordance with the present invention may be associated with a number of different types of wireless devices. The representative mobile terminal 1500 includes a processing/control unit 1502, such as a microprocessor, reduced instruction set computer (RISC), or other central processing module. The processing unit 1502 need not be a single device, and may include one or more processors. For example, the processing unit may include a master processor and associated slave processors coupled to communicate with the master processor.

The processing unit 1502 controls the basic functions of the mobile terminal as dictated by programs available in the program storage/memory 1504. The program storage/memory 1504 may include an operating system 1506 and the host/master process 1508 referred to previously. In one embodiment of the invention, the master process 1508 is stored in non-volatile electrically-erasable, programmable read-only memory, (EEPROM), flash ROM, etc. so that the programs are not lost upon power down of the mobile terminal. The program storage may also include one or more of other types of read-only memory (ROM) and programmable and/or erasable ROM, random access memory (RAM), subscriber interface module (SIM), wireless interface module (WIM), smart card, or other removable memory device, etc. The relevant software for carrying out mobile terminal operations in accordance with the present invention may also be transmitted to the mobile terminal 1500 via data signals, such as being downloaded electronically via one or more networks, such as the Internet and an intermediate wireless network(s).

For performing other standard mobile terminal functions, the processor 1502 is also coupled to user-interface 1510 elements associated with the mobile terminal 1500. The user-interface 1510 may include, for example, a display 1512 such as a liquid crystal display, a keypad 1514, speaker 1516, and microphone 1518. These and other user-interface components are coupled to the processor 1502 as is known in the art. The keypad 1514 includes alpha-numeric keys for performing a variety of functions, including dialing numbers and executing operations assigned to one or more keys. Other user-interface mechanisms may be employed, such as voice commands, switches, touch pad/screen, graphical user interface using a pointing device, trackball, joystick, or any other user interface mechanism. The keypad-1514 will be different depending on the type of mobile terminal utilized.

The device 1500 may also include conventional circuitry for performing wireless transmissions. The DSP 1520 may be employed to perform a variety of functions, including analog-to-digital (A/D) conversion, digital-to-analog (D/A) conversion, speech coding/decoding, encryption/decryption, error detection and correction, bit stream translation, filtering, etc. The transceiver 1522, generally coupled to an antenna 1524, transmits the outgoing radio signals 1526 and receives the incoming radio signals 1528 associated with the mobile terminal.

In accordance with one embodiment of the present invention, one or more sensor modules 1530, 1532 may be permanently or removably coupled to the apparatus 1500. For example, in a sensor module, embodiment employing removable sensor modules 1530, 1532, a mobile terminal such as the mobile terminal 1500 may be used to provide the processing and/or user interface features desired to utilize the particular sensor functionality. The mobile terminal 1500 of FIG. 15 is provided as a representative example of a mobile device in which the principles of the present invention may be applied. From the description provided herein, those skilled in the art will appreciate that the present invention is equally applicable in a variety of other currently known and future mobile devices.

Using the description provided herein, the invention may be implemented as a machine, process, or article of manufacture by using standard programming and/or engineering techniques to produce programming software, firmware, hardware or any combination thereof. Any resulting program(s), having computer-readable program code, may be embodied on one or more computer-usable media, such as disks, optical disks, removable memory devices, semiconductor memories such as RAM, ROM, PROMS, etc. Articles of manufacture encompassing code to carry out functions associated with the present invention are intended to encompass a computer program that exists permanently or temporarily on any computer-usable medium or in any transmitting medium which transmits such a program. Transmitting mediums include, but are not limited to, transmissions via wireless/radio wave communication networks, the Internet, intranets, telephone/modem-based network communication, hard-wired/cabled communication network, satellite communication, and other stationary or mobile network systems/communication links. From the description provided herein, those skilled in the art are readily able to combine software created as described with appropriate general purpose or special purpose computer hardware to create a sensor-based system and method in accordance with the present invention.

The foregoing description of the exemplary embodiment of the invention has been presented for the purposes of illustration and description. It is not intended to be exhaustive or to limit the invention to the precise form disclosed. Many modifications and variations are possible in light of the above teaching. Thus, it is intended that the scope of the invention be limited not with this detailed description, but rather determined from the claims appended hereto.

What is claimed is:

1. A sensor card, comprising:
one or more sensors to respectively collect sensor data;
a memory;
sensor interface circuitry coupled to the one or more sensors to receive the sensor data and to store the sensor data in the memory; and
a digital interface configured for connection to a corresponding digital interface on a mobile communication device, to facilitate access to the memory by a host process operating on the mobile communication device when the sensor card is connected to the mobile communication device via the digital interface.

2. The sensor card as in claim 1, wherein the sensor interface circuitry further comprises a bridge coupled between the one or more sensors and an external memory also implementing the digital interface to facilitate mapping of the sensor data into a defined portion of the external memory, wherein the host process receives the sensor data via the defined portion of the external memory.

3. The sensor card as in claim 2, wherein the bridge comprises means for switching between the defined portion of the external memory and remaining portions of the external memory to allow the host process to access the sensor data and other non-sensor data respectively.

4. The sensor card as in claim 1, further comprising a housing to house the sensor card when the sensor card is not connected to the mobile communication device, wherein the housing comprises a power source to provide power to the sensor card to allow the sensor data to be stored in the memory when the sensor card is housed within the housing.

5. The sensor card as in claim 1, further comprising a substrate housing the one or more sensor elements, the memory, and the sensor interface circuitry.

6. The sensor card as in claim 5, further comprising a housing to encapsulate the substrate.

7. The sensor card as in claim 1, wherein the sensor interface circuitry comprises a memory controller coupled to the digital interface, wherein the memory controller is configured to enable access to the memory by both the sensor interface circuitry and the host process.

8. The sensor card as in claim 7, wherein the memory controller comprises a direct memory access (DMA) controller to facilitate DMA transfers from the sensor interface circuitry to the memory.

9. The sensor card as in claim 1, wherein the digital interface comprises a short range wireless interface for wirelessly coupling the memory and sensor data to the host process operating on the mobile communication device.

10. The sensor card as in claim 9, wherein the short range wireless interface comprises any of a Bluetooth interface and an infrared (IR) interface.

11. The sensor card as in claim 9, wherein the short range wireless interface is further wirelessly coupled to one or more radio frequency (RF)-enabled sensor devices to receive respective sensor data from the RF-enabled sensor devices.

12. The sensor card as in claim 1, wherein the digital interface comprises at least one of a serial interface, an MMC interface, a Serial Peripheral Interface (SPI), RS-232 interface, I²C interface, and Universal Serial Bus (USB) interface.

13. The sensor card as in claim 1, wherein the sensor interface circuitry comprises means for conditioning the sensor data for storing in the memory.

14. The sensor card as in claim 1, wherein the sensor interface circuitry comprises an interface module coupled to the one or more sensors to receive analog sensor data and to provide digital representations of the analog sensor data.

15. The sensor card as in claim 1, wherein the memory comprises non-volatile memory.

16. A method for incorporating sensor functionality into mobile communication devices having a host process and employing at least one removable memory card, comprising:
facilitating access to the removable memory card by the host process using a digital interface;
storing sensor data from one or more sensor modules into a memory;
coupling the host process of the mobile communication device to the memory via the digital interface which is used by the host process to access the removable memory card; and
accessing the sensor data from the memory by the host process via the digital interface.

17. The method of claim 16, wherein storing sensor data comprises storing sensor data into at least a first portion of the memory, and wherein accessing the sensor data from the memory comprises accessing the sensor data from at least the first portion of the memory.

18. The method of claim 16, wherein storing sensor data comprises mapping sensor data from the memory into a defined portion of the removable memory card, and wherein accessing the sensor data from the memory by the host process comprises accessing the sensor data from the defined portion of the removable memory card.

19. The method of claim 18, wherein mapping sensor data from the memory into a defined portion of the removable memory card comprises enabling a bridge to deliver the sensor data from sensor registers to the defined portion of the removable memory card.

20. The method of claim 19, wherein accessing the sensor data from the memory comprises enabling the bridge to deliver the sensor data from the defined portion of the removable memory card to the host process.

21. The method of claim 19, further comprising disabling the bridge to facilitate non-sensor-related memory transactions with the removable memory card from address locations not within the defined portion of the removable memory card.

22. The method of claim 16, further comprising removably coupling the one or more sensor modules and the memory to the mobile communication device.

23. The method of claim 22, wherein removably coupling the one or more sensor modules and the memory to the mobile communication device comprises connecting the one or more sensor modules and the memory to one or more connector slots on the mobile communication device.

24. The method of claim 16, further comprising disconnecting the host process of the mobile communication device from the memory, and storing the sensor data from the one or more sensor modules into the memory when the one or more sensor modules and the memory are disconnected from the host process of the mobile communication device.

25. The method of claim 16, wherein storing sensor data from one or more sensor modules into the memory comprises storing at least some of the sensor data from one or more sensor modules into the memory before coupling the host process of the mobile communication device to the memory.

26. The method of claim 16, wherein storing sensor data from one or more sensor modules into the memory comprises storing at least some of the sensor data from one or more sensor modules into the memory after coupling the host process of the mobile communication device to the memory.

27. The method of claim 16, wherein the removable memory card comprises a MultiMedia card (MMC), and wherein the digital interface comprises an MMC interface.

28. The method of claim 16, wherein the digital interface comprises any of an MMC interface, Serial Peripheral Interface (SPI), RS-232 interface, 12 interface, and Universal Serial Bus (USB) interface.

29. The method of claim 16, wherein storing sensor data from one or more sensor modules into a memory comprises performing direct memory access (DMA) transfers of the sensor data to the memory.

30. A system for providing sensor functionality to mobile devices capable of communicating over a mobile communications network, the system comprising:
modular sensor functionality comprising one or more sensors for gathering sensor data and a sensor memory to store the sensor data;
a modular memory;
a mobile communication device comprising a master process for controlling communication between the master process and one or both of the modular sensor functionality and the module memory; and
a digital interface for facilitating communication over a bus between the master process and the modular sensor functionality, and between the master process and the modular memory.

31. The system as in claim 30, wherein the mobile communication device comprises a processor for executing the master process, and wherein the processor executing the master process is configured to access the sensor data from the sensor memory via the digital interface.

32. The system as in claim 30, wherein the mobile communication device comprises a processor for executing the master process, and wherein the processor executing the master process is configured to access the modular memory via the digital interface.

33. The system as in claim 30, wherein the modular sensor functionality comprises a sensor interface coupled to the one or more sensors and to the modular memory to facilitate storing of the sensor data in the modular memory via the digital interface.

34. The system as in claim 33, wherein the mobile communication device comprises a processor for executing the master process, and wherein the processor executing the master process is configured to access the sensor data from the modular memory via the digital interface.

35. The system as in claim 34, further comprising a bridge coupled between the processor for executing the master process and the modular memory to manage memory accesses to and from the module memory by the master process and the modular sensor functionality.

36. The system as in claim 30, wherein host process is detached from the sensor functionality, and wherein the modular sensor functionality operates in a stand-alone mode to write the sensor data to the modular memory for subsequent retrieval by the mobile communication device when the mobile communication device is re-attached to the sensor functionality.

37. The system as in claim 30, wherein the digital interface comprises a MultiMedia Card (MMC) interface, and wherein the modular memory comprises an MMC-compliant memory card.

38. The system as in claim 30, wherein the host process comprises a mobile phone engine operable to control communications over a cellular network.

39. A mobile device having a scalable sensor system and capable of communicating wirelessly over a mobile communications network, the mobile device comprising:
a processor configured to execute a host process;
at least one modular card having sensor functionality implemented thereon to gather sensor data;
one or more slots for receiving the modular cards; and
a scalable digital interface to couple the sensor functionality of the modular cards to the host process operating on the mobile device.

40. The mobile device as in claim 39, further comprising a memory coupled to the scalable digital interface, and wherein the modular card having sensor functionality implemented thereon further comprises a bridge coupled between the sensor functionality and the memory to facilitate mapping of the sensor data into a defined portion of the memory, wherein the host process receives the sensor data via the defined portion of the memory.

41. The mobile device as in claim 39, wherein mobile device comprises a mobile phone or a personal digital assistant (PDA).
